(19) United States
(12) Patent Application Publication
(10) Pub. No.: US 2008/0135319 A1
(43) Pub. Date: Jun. 12, 2008

(54) Detachable Vehicle Configured for Convenient Towing or Transport

(76) Inventor: Richard Clifford Lynn, Valley, AL (US)

Correspondence Address: PHILIP H. BURRUS, IV, 460 Grant Street, Atlanta, GA, 30312, US

(21) Appl. No.: 11/567,440

(22) Filed: Dec. 6, 2006

(51) Int. Cl. B62D 61/08; B62K 15/00; B62K 5/02

(52) U.S. Cl. 180/208; 180/210; 280/638

(57) ABSTRACT

A detachable vehicle (100) is configured for quick disassembly so as to be conveniently towed or transported. A front fork assembly (103) is detachable from a chassis (101) and is stowable within the chassis (101). The front fork assembly (103) includes a pair of fork members (106,107) that are pivotally coupled to a steering member (108), which is pivotally coupled to a chassis connecting member (109). A handlebar assembly (104) is also detachable. When the front fork assembly (103) is detached from the vehicle (100) and stored within the chassis (101), the vehicle (100) may be towed by way of a hitch (705) or carried within the bed of a pick-up truck or van.

### BACKGROUND

1. Technical Field

This invention relates generally to a vehicle having parts configured for disassembly, and more specifically to a multi-person vehicle having removable parts that may be stowed within a chassis, such that the vehicle may be conveniently towed or transported.

2. Background Art

Automobiles are widely used as convenient transportation. Where roads, thoroughfares, and highways are available, automobiles provide a safe and reliable means of travel.

In certain situations, however, automobiles are of little use. In certain crowded environments, such as a sporting event, convention, or other public gathering, an automobile may be too bulky and too large to be used as for transportation. By way of example, during the week of the Auburn-Alabama football game, fans come from miles around with campers and recreational vehicles. Fans often park these vehicles very close together in campgrounds or other community gathering spots. Similarly, when NASCAR has a race at a particular track, such as the Talladega Superspeedway, fans pack campers, motor homes, and recreational vehicles into the track infield, thereby leaving little space between each other. In such environments, an automobile simply is not suitable for use for transportation, as there is simply not enough room for an auto to pass between the fans and the many parked vehicles.

People at such events, however, still require transportation, as they often arrive many days in advance. They may want to be able to move about the gathering site to visit with other fans, purchase food, beverages, and souvenirs, or simply explore the area. They thus need a vehicle small enough to fit between the many campers, mobile homes, and recreational vehicles.

On mode of transport that a person may select is a motorcycle. Carrying assemblies, suitable for mounting on mobile homes and recreational vehicles, are available such that a small motorcycle may be attached to the mobile home. Once at the gathering site, the person may unload the motorcycle and use it for transport. Motorcycles have limitations, however, in that only one person may generally ride at a time. If a motorcycle is large enough to carry two people, a separate trailer is generally required. Towing a trailer is bulky and cumbersome.

A second solution that may be used is the conventional golf cart. While a golf cart may be small enough to move about the gathering site, they are not optimal transportation solutions for a variety of reasons. First, most golf carts are electric, which means that they must have a charging source for power. Many recreational areas do not have such charging outlets. Second, a golf cart can only transport two people at a time. When a family wants to travel, some may have to walk since only two people fit on the seat. Third, towing a golf cart is just like towing an automobile—it requires an expensive and bulky trailer.

There is thus a need for an improved vehicle suitable for transportation in congested areas that accommodates multiple riders, and that is configured for convenient towing or transport when not in use.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a perspective view of a detachable vehicle in accordance with one embodiment of the invention.

FIG. 2 illustrates a perspective view of a detachable vehicle having its seats moved to an open position with a front fork assembly, handlebar assembly, and front wheel stowed within the chassis in accordance with one embodiment of the invention.

FIG. 3 illustrates a view of the front face of a detachable vehicle, along with a front fork assembly, handlebar assembly, and front wheel detached, in accordance with one embodiment of the invention.

FIG. 4 illustrates front forks of a front fork assembly being rotated from a first, stowable position to a second, extended position in accordance with one embodiment of the invention.

FIG. 5 illustrates a chassis connecting member of a front fork assembly being inserted into the front face of a chassis of a detachable vehicle in accordance with one embodiment of the invention.

FIG. 6 illustrates a side view of an assembled, detachable vehicle having a front fork assembly connected to the chassis and both a front and rear foot plates rotated from a retracted position to an extended position in accordance with one embodiment of the invention.

FIG. 7 illustrates a perspective view of a detachable vehicle having the front fork assembly, handlebar assembly, and front wheel stowed within the chassis, with a hitch assembly for conveniently towing the detachable vehicle illustrated in accordance with one embodiment of the invention.

FIG. 8 illustrates one embodiment of a hitch assembly coupled to a standard hitch on an auxiliary vehicle in accordance with the invention.

FIG. 9 illustrates a hitching member being coupled to a hitch assembly in accordance with one embodiment of the invention.

FIG. 10 illustrates a retractable cable being coupled from a winch to a cable coupling member and then to a bracing member in accordance with one embodiment of the invention.

FIG. 11 illustrates a rear view of a detachable vehicle having the front fork assembly, handlebar assembly, and front wheel stowed within the chassis and the rear wheels removed, such that the detachable vehicle is capable of fitting within a pick-up truck bed or recreational vehicle cargo space in accordance with one embodiment of the invention.

Skilled artisans will appreciate that elements in the figures are illustrated for simplicity and clarity and have not necessarily been drawn to perfect scale. For example, the dimensions of some of the elements in the figures may be exaggerated relative to other elements to help to improve understanding of embodiments of the present invention.

### DETAILED DESCRIPTION OF THE INVENTION

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

As illustrated and described herein, a detachable vehicle is designed for convenient transport or towing. The vehicle is described as “detachable” in that various parts, such as a front fork assembly or front wheel, are capable of being conveniently removed and stowed so as to reduce the overall volume of the vehicle such that it may be conveniently towed or transported when not in use. For instance, in one embodiment, a front fork assembly, handlebar assembly, and front wheel may be quickly and easily removed from the chassis, and stowed within the chassis, such that the overall volume of the detached vehicle is capable of fitting within a standard pick-up truck bed or recreational vehicle cargo hold. Further, in one embodiment, once disassembled, a towing assembly is provided such that the vehicle may be towed with a standard two-inch trailer hitch mounting without any need for a trailer or other mounting apparatus.

In one embodiment, the vehicle is configured to accommodate at least four passengers, with two facing forward and two facing the rear. The vehicle, while well suited for everyday use, is particularly well suited to crowded environments where little space is available between parked cars, campers, and the like. Referring to the college football and NASCAR examples above, the vehicle provides a means of transportation for at least four people, that is small enough to be mobile in these environments, yet that can be easily towed or transported without the need for bulky trailers or other accessories.

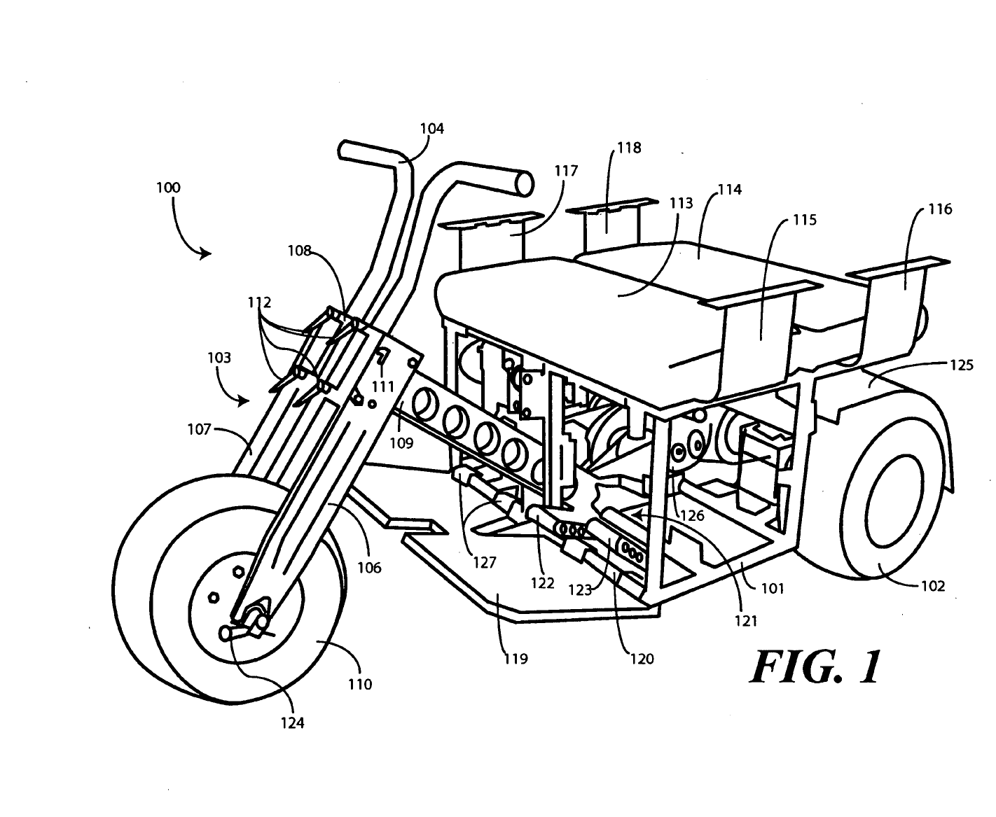

Turning now to FIG. 1, illustrated therein is a perspective view of a detachable vehicle 100 in accordance with one embodiment of the invention. In the embodiment of FIG. 1, the detachable vehicle 100 is a three wheel vehicle configured to be selectively disassembled for easy transport. The vehicle 100 includes a chassis 101 that is generally rectangular in shape, and is fabricated of tubular metal. In one embodiment, the chassis 101 measures approximately 32 inches in length, 34 inches in depth, and 18 inches in height.

The chassis 101 houses an engine 126 and drive train, and includes extra storage space for various components of the vehicle 100 as will be illustrated and described. While the engine 126 may be either electric or gas, gas is sometimes preferred as no charging source is required for batteries. One example of a suitable engine 126 for the vehicle 100 is a 5½ horsepower, four-stroke engine manufactured by Honda. Similar engines, such as those manufactured by other companies, including Briggs and Stratton, may also be used.

The chassis 101 has two rear wheels 102 coupled thereto. The rear wheels 102, which are protected by a metal or plastic fender 125, are separated by an axle connected to the drive train and engine 126. The rear wheels 102 are coupled to the vehicle 100 with a set of four lug nuts per wheel.

A front fork assembly 103 couples the front wheel 110, which is detachable, to the vehicle 100. So that the vehicle 100 may be easily transported or towed, the front fork assembly 103 is detachable and separable from the chassis 101. Once the front fork assembly 103 is detached from the chassis 101, the front fork assembly is stowable within the chassis 101. The front wheel 110 is detachable, in one embodiment, by a manual wheel lock 124.

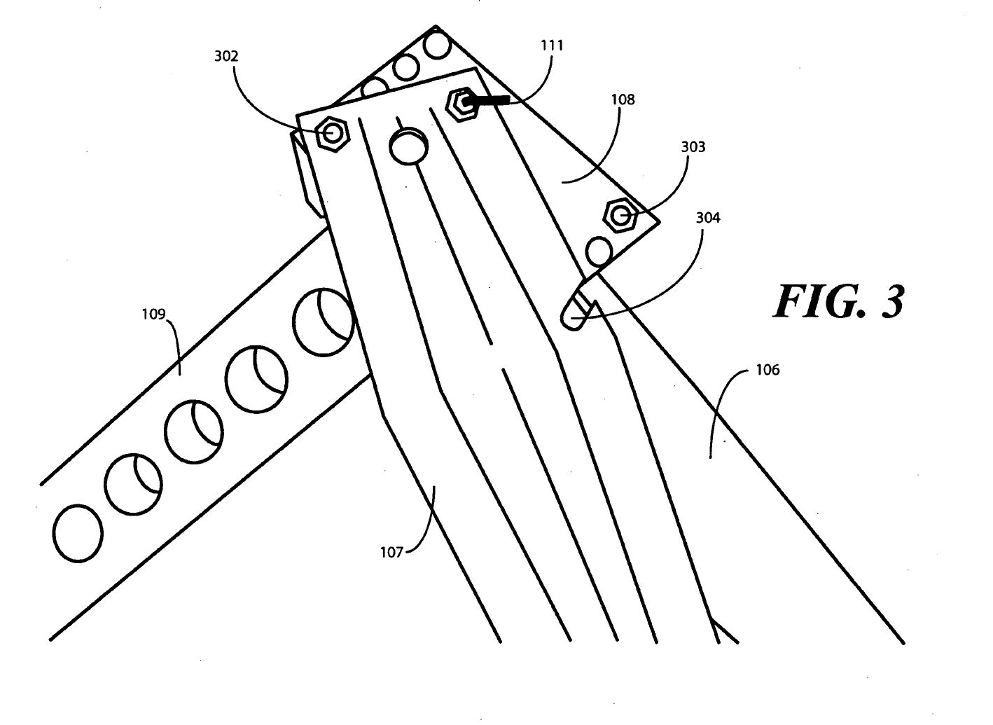

The front fork assembly 103 includes a handlebar assembly 104 that is also detachable. The handlebar assembly 104, which may be manufactured from tubular metal, inserts into a steering member 108 separating the two forks 106,107 of the front fork assembly 103. Specifically, the steering member 108, which is pivotally coupled to a chassis connecting member 109, includes at least one handlebar assembly receiving aperture (shown in more detail in FIG. 3) into which the handlebar assembly 104 is inserted. The handlebar assembly 104 is rigidly affixed to the front fork assembly 103 when one or more torque locks 112 are tightened to a locked position.

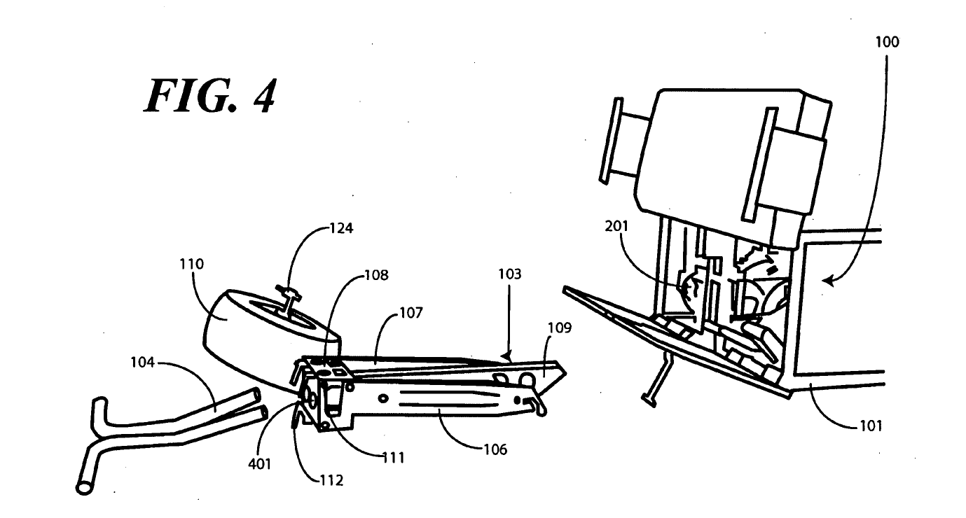

Two front fork members 106,107 are pivotally coupled to the steering member 108. The front fork members 106,107 are configured to rotate (as shown in FIG. 4) from a first position where the front fork members 106,107 are essentially parallel with the chassis connecting member 109 such that the front fork assembly may be stowed within the chassis 101, to a second, extended position for supporting the front wheel 110 as shown in FIG. 1.

Two seat members 113,114 sit atop the chassis 101. The seat members 113,114 are pivotally coupled to the chassis 101 such that when opened, a central cavity within the chassis 101 is exposed. The seat members 113,114 are coupled to top edge members of the chassis 101 which, in one embodiment, are tubular metal pieces forming the top, outer edges of the chassis 101. The two seat members 113,114 are manufactured, in one embodiment, of foam filled vinyl so as to be resistant to weather, rain, and the elements. The two seat members 113,114 are approximately 34 inches in width, with each seat member being 16 inches in depth. In such a configuration, the vehicle is easily capable of accommodating at least four adults.

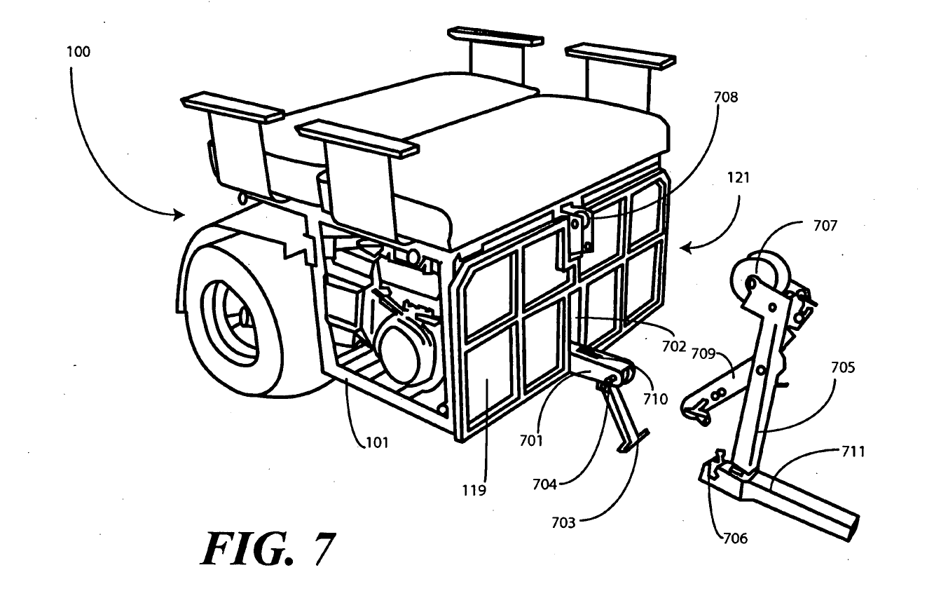

Each seat member 113,114, in one embodiment, includes a pair of side members 115,116,117,118 projecting outwardly and upward from the edges of the seat members 113,114. The side members 115,116,117,118 serve several functions. First, when passengers are riding on the vehicle 100, the side members 115,116,117,118 serve as arm rests for added comfort. Next, when the vehicle 100 is disassembled for towing, the front side members 115,117 serve as a handle with which a user may easily and conveniently connect the vehicle 100 to a hitch assembly. This connection to a hitch assembly will be illustrated in more detail in the discussion of FIGS. 7, 8, 9, and 10.

A front foot plate 119 is pivotally coupled to the chassis 101. In one embodiment, the front foot plate 119 is pivotally coupled to a first base member 120 of the chassis by way of one or more hinge members 127. The hinge members 127 may be either traditional pin type hinges, or, where the first base member 120 comprises a tubular steel element, the hinge members 127 may be couplings that are connected to the front foot plate 119 and circumscribe the first base member 120. In such a configuration, when the front foot plate 119 rotates from a retracted position to an extended position, the hinge members 127 simply rotate about the first base member 120.

The front foot plate 119 is capable of rotating from a first, retracted position to an extended position. When the front foot plate 119 is in the retracted position, the front foot plate 119 substantially covers a front face 121 of the chassis 101. The retracted position not only serves as protection from objects potentially damaging the engine 126 and drive train while the vehicle 100 is in transport, but also reduces the overall volume of the vehicle 100 such that it may be easily stowed in a pick-up truck bed or recreational vehicle cargo hold.

When the front foot plate 119 is in the extended position, the front foot plate serves as a foot rest for passengers sitting on the front seat member 113. When the front foot plate 119 is in the extended position, as shown in FIG. 1, the front foot plate 119 extends outward from the chassis 101 at an angle of between 60 and 90 degrees relative to the front face 121 of the chassis 101.

Two pedals 122,123 extend outwardly from the front face 121 of the chassis 101. The pedals 122,123 are coupled to the transmission and drive train and serve as a brake pedal and an accelerator pedal. In one embodiment, the drive train is a belt driven torque converter, operating single gear transmission with only an accelerator and a brake. Where the transmission includes gears that may be selectively switched by a driver, a third pedal may be added. Where the transmission is an automatic transmission, only two pedals are required. It will be clear to those of ordinary skill in the art having the benefit of this disclosure that other pedals and controls, such as a parking brake and corresponding lever or pedal, may be added to the vehicle 100 as well.

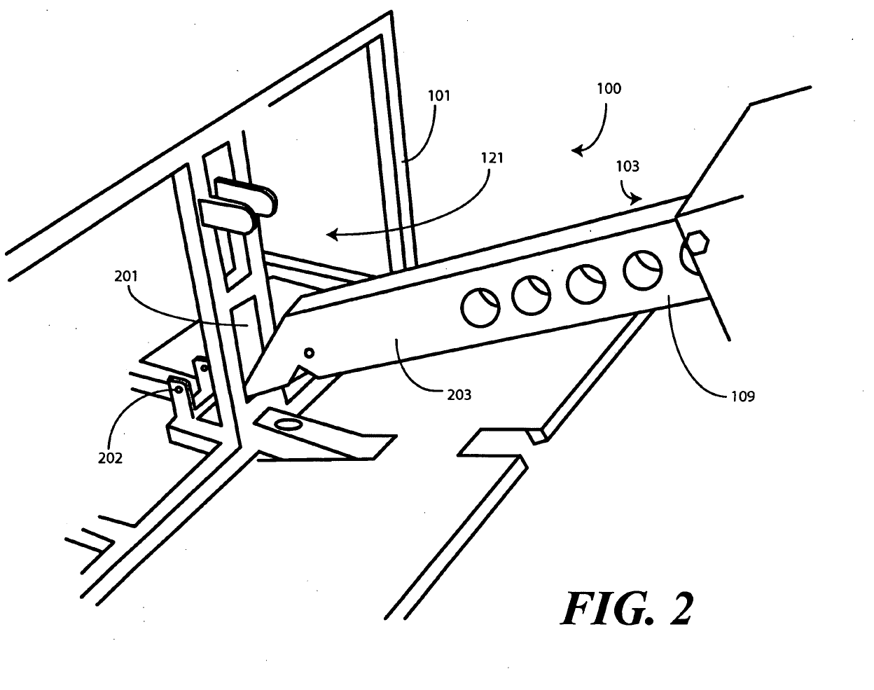

Turning now to FIG. 2, the detachability of the vehicle 100 will be explained in more detail. As noted above, the front fork assembly 103 includes a chassis connecting member 109 that couples the front fork assembly 103 to the chassis 101. When the chassis connecting member 109 is coupled to the chassis 101, the chassis connecting member 109 projects outwardly from the chassis at an angle of between 25 and 75 degrees relative to the front face 121 of the chassis 101, preferably at an angle of between 30 and 60 degrees.

The chassis 101 includes a chassis connecting member aperture 201 into which the chassis connecting member 109 is inserted for attachment (or removed for disassembly). A chassis connecting locking mechanism 202,203 is used to securely couple the chassis connecting member 109 to the chassis 101, with the rigid perimeter of the chassis connecting member aperture 201 providing stabilization support. In one embodiment, the chassis connecting locking mechanism 202,203 comprises a metal pin inserted through mating holes in both the chassis 101 and the chassis connecting member 109. It will be clear to those of ordinary skill in the art having the benefit of this disclosure that other locking mechanisms, including torque locks, pivoting locks, and adjustable clasps, may also be used as the chassis connecting locking mechanism 202,203.

Turning now to FIG. 3, once the chassis connecting locking mechanism (202,203) has been released and the chassis connecting member 109 has been removed from the chassis (101), The front forks 106,107 may be rotated from the extended position (shown in FIG. 1) to a retracted position. The rotation is possible because the two front forks 106,107 are pivotally coupled to the steering member 108 on opposite sides of the steering member 108. The front forks 106,107 are coupled to the steering member 108 and rotate with respect to the steering member 108 by way of a pivoting stop 302.

When rotating to the extended position, a mechanical stop recess 304 on each front fork 106,107 engages a mechanical stop 303 disposed on each side of the steering member 108. The mechanical stop 303 limits the amount of extension of the two front forks 106,107 and ensures proper alignment of the two front forks 106,107 for engagement with the front wheel (110).

At least two locking mechanisms 111, one such locking mechanism being disposed on each fork 106,107, rigidly couple the front forks 106,107 to the steering member 108 in the second, extended position. To disassemble the vehicle 100, one simply unlocks the locking mechanisms 111 and then pivots the front forks 106,107 from the extended position to the stowable position.

Turning now to FIG. 4, illustrated therein is a perspective view of the vehicle 100 when the front fork assembly 103 has been removed from the chassis 101 by removing the chassis connecting member 109 from the chassis connecting member aperture 201. The front forks 106,107 have been rotated from the extended position to the stowable position by unlocking the locking mechanisms 111 and rotating the front forks 106,107. The front wheel 110 has been detached from the front forks 106,107 by releasing the wheel lock 124. The handlebar assembly 104 has been removed from the steering member 108 by releasing the torque locks 112 and removing the handlebar assembly 104 from the handlebar assembly apertures 401.

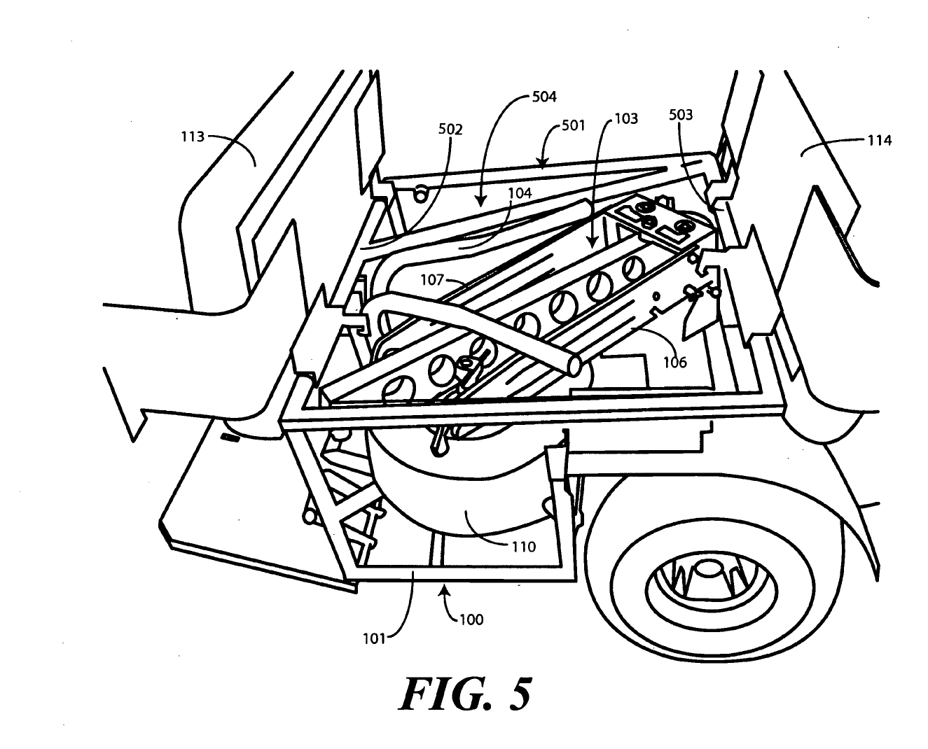

Turning now to FIG. 5, illustrated therein is a perspective view of a detachable vehicle 100 having its seat members 113,114 moved to an open position. Several of the vehicular components, including the front fork assembly 103, handlebar assembly 104, and front wheel 110 have been detached and stowed within the chassis 101 in accordance with one embodiment of the invention.

When the seat members 113,114 are in the closed position, as was the case in FIG. 1, the seat members 113,114 covered the top face 501 of the chassis 101. When the seat members 113,114 are in the open position, as is the case in FIG. 2, the top face 501 of the chassis 101 is exposed.

The engine (126) is placed towards the side of the chassis 101, thereby leaving room for component storage. As noted in the discussion of FIG. 4, to facilitate easy and convenient transport and towing, the front wheel 110 detaches from the two fork members 106,107. The handlebar assembly 104 detaches from the front fork assembly 103 when the torque locks (112) are released. The front fork assembly 103 then detaches from the chassis 101. Once the front forks 106,107 are pivoted to the stowable position, all three components may be placed in the chassis 101 for storage. To accommodate this storage, complimentary features, such as recesses configured to receive the handlebar assembly 104, front wheel 110 and front fork assembly 103 are disposed within the chassis 101.

As illustrated in FIG. 5, the seat members 113,114 are pivotally coupled to opposing top edge members 502,503 of the chassis. When the seat members 113,114 are opened, the front seat member 113 pivots about the front edge member 502, and the rear seat member 114 pivots about the rear edge member 503 to expose the center cavity 504 of the chassis 101. As with the hinges employed for the front foot plate (119), the hinges for the seat members may be either traditional pin type hinges, or, where the front edge member 502 comprises a tubular steel element, the hinge may be one or more couplings that are connected to the seat member 113 and circumscribe the front edge member 502. In such a configuration, when the front seat member 113 rotates from a closed position to an open position, the hinges simply rotate about the front edge member 502.

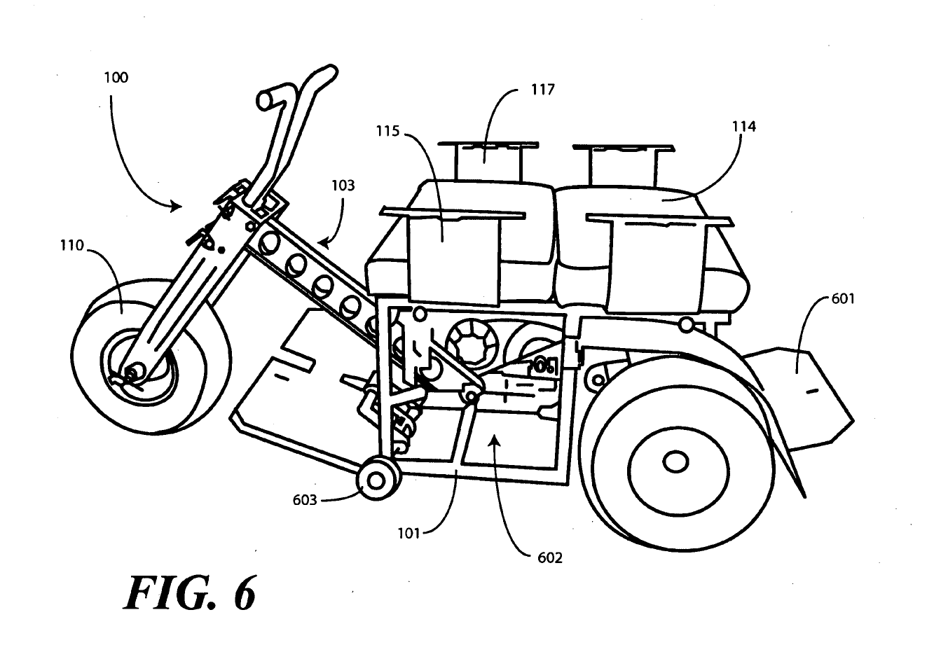

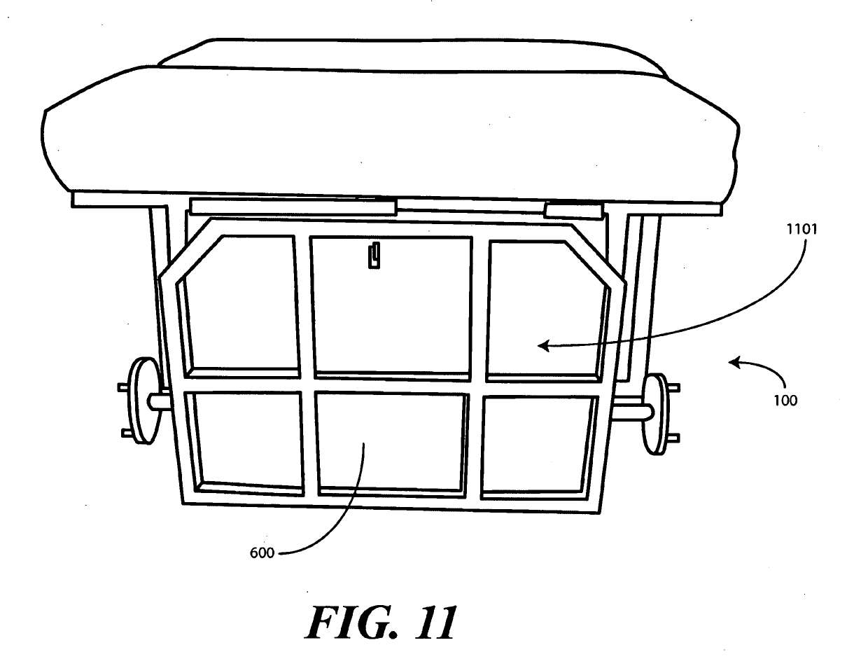

Turning now to FIG. 6, illustrated therein is a side view of the vehicle 100 when assembled. From the view of FIG. 6, the rear foot plate 601 may be seen. As with the front foot plate (119), the rear foot plate 601 is pivotally coupled to a second base member (the second base member is similar to the first base member (120) in that it spans the bottom rear portion of the chassis (101)) of the chassis 101. The second base member is disposed opposite the first base member (120) along the bottom face 602 of the chassis 101. As will be shown in more detail in FIG. 11, when the rear foot plate 601 is in a retracted position, the rear face of the chassis is covered by the rear foot plate 601. When the rear foot plate 601 is in the extended position, as shown in FIG. 6, the rear foot plate 601 extends at an angle of between 25 and 75 degrees from the rear face of the chassis 101, preferably between 30 and 60 degrees.

The rear foot plate 601 serves multiple purposes. One purpose is that of a foot rest for passengers sitting on the rear seat member 114. A second purpose is that of a lever when the front fork assembly 103 and front wheel 110 are detached from the chassis 101. Specifically, by placing a foot on the rear foot plate 601, and grasping the front side members 115,117, a person can easily cause the front portion of the chassis to lift off the ground. This lifting action is useful for connecting the vehicle 100 to a hitch assembly, as will be described in the figures that follow.

Optional front wheels 603 may be coupled to the chassis 101. As shown in FIG. 6, the optional front wheels 603 may be small wheels coupled to the front base member (120) of the chassis. The optional front wheels 603 serve two functions: first, they provide a stabilizing force in the event a user makes two sharp a turn on the vehicle 100. Second, when the front wheel 110 and front fork assembly 103 are detached, the optional front wheels allow the vehicle 100 to be rolled on four wheels without requiring the user to balance the vehicle on the rear wheels by way of the rear foot plate 601.

Turning now to FIG. 7, the hitching assembly and means of configuring the vehicle 100 for towing will be described in detail. In one embodiment, the vehicle 100 includes a hitching member 701 that is coupled to the chassis 101 and extends distally from the front face 121 of the chassis 101. When the front foot plate 119 is closed, the hitching member 701 extends through a hitching member aperture 702 disposed in the front foot plate 119. When the front foot plate 119 is moved from the extended position to the closed position, the hitching member 701 protrudes through the hitching member aperture 702.

Coupled to the hitching member 701 is a retractable kickstand 703. When the vehicle 100 is in use, the kickstand 703 is retracted into the hitching member 701. When the front fork assembly (103) is detached from the chassis 101, the kickstand 703 may be moved to an extended position so as to bias the front face of the chassis 101 off the ground.

The hitching member 701 includes a pair of hitching pins 704 that extend distally from opposite sides of the hitching member 701. The hitching pins 704 are configured to mate with hitching pin recesses 706 in the hitch 705. The hitch 705, which in one embodiment is mountable on a standard 2″ square trailer hitch receiver by way of a mounting post 711, employs the hitching pin recesses 706 to receive each of the hitching pins 704 when the vehicle is being towed by way of the hitch 705.

The hitch 705 also includes a bracing member 709 pivotally coupled to the hitch 705. When the vehicle 100 is being coupled to the hitch 705, the bracing member mates with and is received by a bracing member coupler 710 in the hitching member 701. The bracing member coupler 710 may include pins or locking mechanisms to retain the bracing member 709 to the bracing member coupler 710.

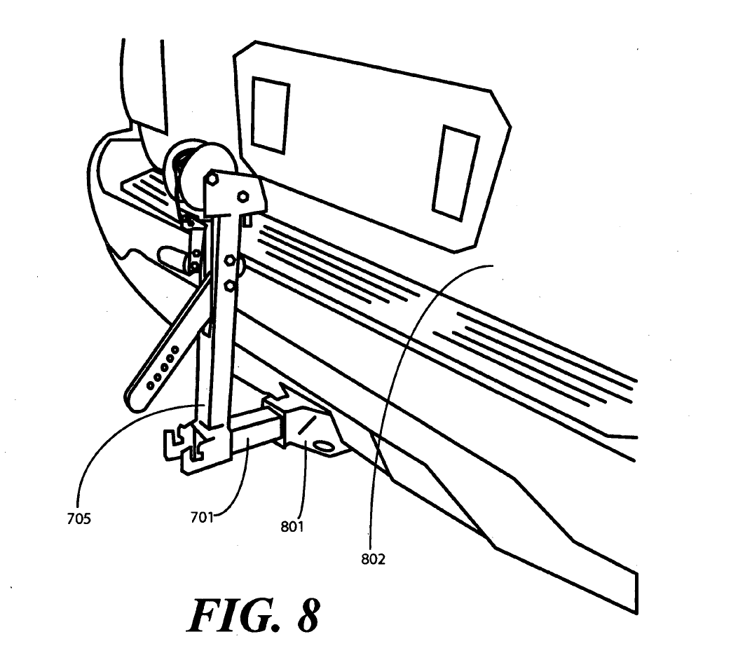

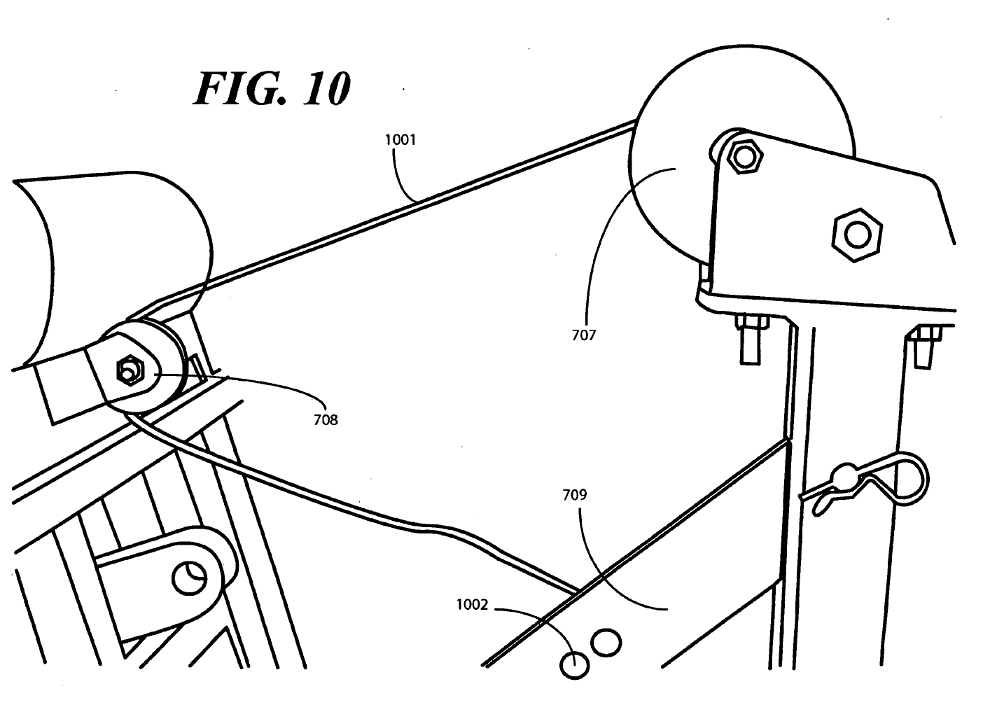

The hitch 705 further includes a winch 707 having a retractable cable extending therefrom. The retractable cable (shown in FIGS. 8 and 10) extends from the winch 707 about a cable coupler 708 to the bracing member 709. When the cable is retracted, the hitching pins 704 in the hitching pin recesses 706 act as a fulcrum about which the vehicle pivots, thereby lifting the vehicle 100 off the ground for convenient towing.

Turning now to FIG. 8, illustrated therein is the hitch 705 upon being coupled to a standard 2″ hitch assembly 801 of an auxiliary vehicle 802. Specifically, the mounting post 711 has been inserted and locked in a 2″ receiver trailer hitch assembly 801. By using the hitch 705 in this fashion, as the hitch 705 causes the vehicle (100) to lift off the ground, a user is able to conveniently tow the vehicle (100) without a need for trailers or other mounting means.

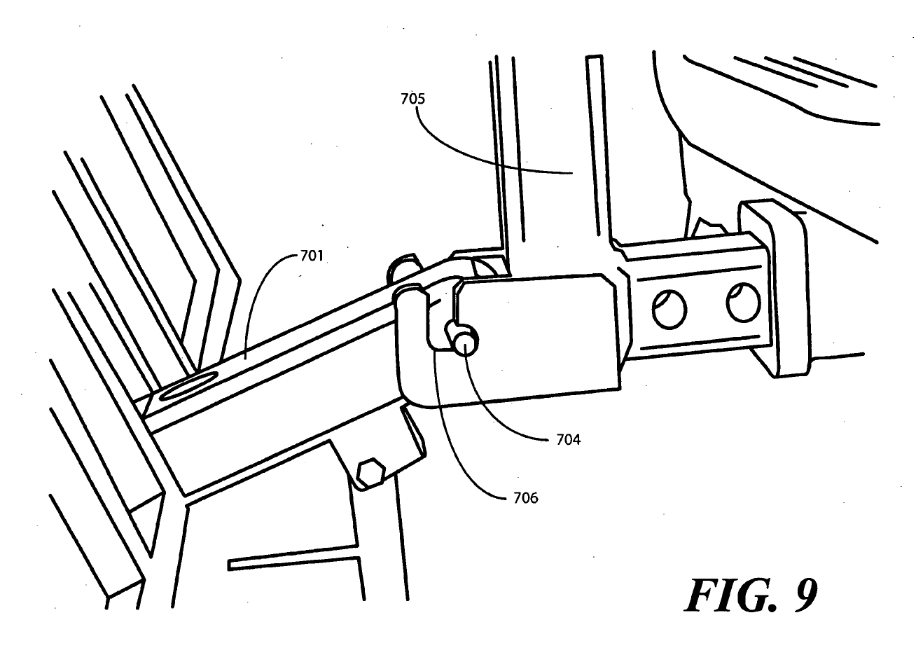

Turning now to FIG. 9, illustrated therein is the first phase of connecting the vehicle (100) to the hitch 705. In FIG. 9, the front of the vehicle (100) is lifted off the ground such that the hitching pins 704 extending from the hitching member 701 mate with the hitching pin recesses 706. One method with which this may be achieved is by stepping on the rear foot plate (601) and grasping the two front vertical members 115,117. Using the rear wheels 102 as a pivot, a user is able to simply and with little effort lift the vehicle (100) such that the hitching pins 704 mate with the hitching pin recesses 706.

Turning now to FIG. 10, illustrated therein is the action of the retractable cable 1001. Once the hitching pins (704) are seated within the hitching pin recesses (706), the retractable cable 1001 may be extended from the winch 707, about the cable coupler 708. The retractable cable 1001 may then be coupled to the bracing member 709 by way of one of several cable coupling holes 1002. As noted above, when the cable 1001 is retracted, the hitching pins (704) in the hitching pin recesses (706) act as a fulcrum about which the vehicle pivots, thereby lifting the vehicle (100) off the ground for convenient towing.

Turning now to FIG. 11, illustrated therein is a rear view of the vehicle 100 with the rear foot plate 601 moved to the retracted position. As can be seen, when the rear foot plate 601 is in the retracted position, the rear foot plate substantially covers the rear face 1101 of the vehicle 100.

In the embodiment shown in FIG. 11, the rear wheels (102) have been removed, thereby further reducing the overall volume of the vehicle. In this configuration, the vehicle 100 conveniently fits within the bed of a standard pick-up truck. Such a configuration is advantageous when no receiver is available for the hitch (705).

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A three-wheel vehicle configured to be selectively disassembled, comprising:
a. a chassis having two rear wheels coupled thereto; and
b. a front fork assembly, separable from the chassis, and stowable within the chassis, the front fork assembly comprising:
i. a handlebar assembly;
ii. a fork assembly comprising two fork members coupled by a steering member to a chassis connecting member; and
iii. a detachable wheel.

2. The three-wheel vehicle of claim 1, wherein the two fork members are pivotally coupled to the steering member on opposite sides the steering member, wherein the steering member comprises a mechanical stop on each side of the steering member configured to engage a mechanical stop recess disposed in each of the two fork members when the fork members pivot from a first, stowable position to a second, extended position.

3. The three-wheel vehicle of claim 2, further comprising at least two locking mechanisms for rigidly coupling the two fork members to the steering member in the second, extended position.

4. The three-wheel vehicle of claim 2, wherein the chassis comprises a chassis connecting member aperture and a chassis connecting locking mechanism configured to couple the chassis connecting member to the chassis such that the chassis connecting member extends from a front face of the chassis at an angle of between 30 and 60 degrees.

5. The three-wheel vehicle of claim 2, wherein the steering member comprises at least one handlebar assembly receiving aperture and at least one torque lock, wherein when the handlebar assembly is inserted into the at least one handlebar assembly receiving aperture and the at least one torque lock is locked, the handlebar assembly is rigidly coupled to the steering member.

6. The three-wheel vehicle of claim 2, wherein the steering member is fixedly and pivotally coupled to the chassis connecting member.

7. The three-wheel vehicle of claim 1, further comprising at least one seat member pivotally coupled to the chassis so as to cover a top face of the chassis.

8. The three-wheel vehicle of claim 7, wherein the at least one seat member comprises two seat members, each of the two seat members being pivotally coupled to opposing top edge members of the chassis, such that a central cavity of the chassis is exposed when each of the two seat members is opened.

9. The three-wheel vehicle of claim 8, wherein each of the two seat members comprises a pair of side members projecting outwardly from the two seat members.

10. The three-wheel vehicle of claim 1, further comprising a front foot plate pivotally coupled to a first base member of the chassis such that when the front foot plate is in a retracted position, a front face of the chassis is covered by the front foot plate.

11. The three-wheel vehicle of claim 10, wherein when the front foot plate is in an extended position, the front foot plate extends at an angle of between 60 and 90 degrees from the front face.

12. The three-wheel vehicle of claim 10, further comprising a rear foot plate pivotally coupled to a second base member of the chassis, the second base member being disposed opposite the first base member along a bottom face of the chassis, such that when the rear foot plate is in a retracted position, a rear face of the chassis is covered by the rear foot plate.

13. The three-wheel vehicle of claim 12, wherein when the rear foot plate is in an extended position, the rear foot plate extends at an angle of between 60 and 90 degrees from the rear face.

14. The three-wheel vehicle of claim 10, further comprising a hitching member coupled to the chassis and extending distally from the front face of the chassis, wherein the front foot plate comprises a hitching member aperture through which the hitching member protrudes.

15. The three-wheel vehicle of claim 14, wherein the hitching member comprises a kickstand configured to bias the front face of the chassis off the ground when in an extended position.

16. The three-wheel vehicle of claim 14, wherein the hitching member comprises two hitching pins extending distally from opposite sides of the hitching member.

17. A three-wheel vehicle towing system, comprising:
a. a three-wheel vehicle configured for disassembly comprising a chassis having two rear wheels coupled thereto and a front fork assembly, separable from the chassis, and stowable within the chassis, the front fork assembly comprising: a handlebar assembly, a fork assembly comprising two fork members coupled by a steering member to a chassis connecting member; and a detachable wheel;
b. a hitching member extending distally from a front face of the chassis, the hitching member having at least two hitching pins extending distally from sides of the hitching member; and
c. a hitch, the hitch comprising at least two hitching pin recesses configured to receive each of the at least two hitching pins extending distally from the sides of the hitching member and a winch having a retractable cable.

18. The three-wheel vehicle towing system of claim 17, wherein the chassis comprises a cable coupler configured to couple to the retractable cable.

19. The three-wheel vehicle towing system of claim 18, further comprising a bracing member extending from the hitch, wherein the chassis further comprises a bracing member coupler configured to receive the bracing member.

20. The three-wheel vehicle towing system of claim 19, wherein the hitch comprises a mounting post configured to couple to a two-inch receiver trailer hitch assembly of an auxiliary vehicle.
